(19) United States
(12) Patent Application Publication
(10) Pub. No.: US 2026/0075428 A1
(43) Pub. Date: Mar. 12, 2026

(54) PROTECTING NETWORK DATA OF RUGGED FIREWALLS DURING PHYSICAL INTRUSIONS OF OPERATIONAL TECHNOLOGY (OT) DEVICES

(71) Applicant: Fortinet, Inc., Sunnyvale, CA (US)

(72) Inventor: Gerardo Andrés Mendel, Salvador (BR)

(73) Assignee: Fortinet, Inc., Sunnyvale, CA (US)

(21) Appl. No.: 18/883,844

(22) Filed: Sep. 12, 2024

(51) Int. Cl. H04W 12/63; H04W 12/088; H04W 12/37

(52) U.S. Cl. CPC H04W 12/63; H04W 12/088; H04W 12/37

(57) ABSTRACT

A rugged firewall of an OT device includes sensitive network data stored on a memory device. A current GPS position of an OT device is determined, and a tolerable deviation in GPS position is received for the OT device from the current GPS position as defined by a network security policy. A violation of the tolerable deviation is detected in the OT device from the current GPS position. In response to the detected violation, a security action involving a self-reset is taken to destroy network data in the rugged firewall of the OT device.

### FIELD OF THE INVENTION

The invention relates generally to computer networks, and more specifically, for protecting network data during physical intrusions of operational technology (OT) devices.

### BACKGROUND

Computer networking devices are susceptible not only to entry by remote hacking of software processes, but also to physical intrusions. Some non-traditional devices, such as OT devices and IoT devices, have been modified or retrofitted for operation on a computer network, but lack the sophisticated network security processes of traditional information technology (IT) devices.

For example, remote ATMs (Automatic Teller Machines) are a type of OT that can have traditional alarm systems to protect currency. However, an ATM machine can be broken into to expose currency, and at the same time, to expose sensitive data on embedded networking devices. Traditional ATM alarm systems are limited to preventing and notifying of physical break-ins. Meanwhile, traditional firewall systems are limited to preventing software intrusions from remote network hackers.

Therefore, what is needed is a robust technique for protecting network data during physical intrusions of OT devices.

### SUMMARY

To meet the above-described needs, methods, computer program products, and systems for protecting network data during physical intrusions of OT devices.

In one embodiment, sensitive network data for a rugged firewall is stored on a memory (e.g., a flash memory). A current GPS position of an OT device with the rugged firewall is determined. A tolerable deviation in GPS position is received for the OT device from the current GPS position as defined by a network security policy.

In another embodiment, a violation of the tolerable deviation is detected from the current GPS position. In response to the detected violation, a security action involving a self-reset is taken to destroy network data in the rugged firewall of the OT device.

Advantageously, network performance and OT devices are improved with better network security measures.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for protecting network data during physical intrusions of OT devices, according to some embodiments.

FIG. 2 is a more detailed block diagram illustrating an ATM machine of the system of FIG. 1, according to an embodiment.

FIG. 3 is a more detailed block diagram illustrating an OT rugged firewall, according to an embodiment.

FIG. 4 is a high-level flow diagram illustrating a method for protecting network data during physical intrusions of ATM devices, according to an embodiment.

FIG. 5 is a flow diagram illustrating a step of detecting physical intrusions of an ATM device, from the method of FIG. 5, according to an embodiment.

FIG. 6 is a block diagram illustrating an example computing device for the system of FIG. 1, according to an embodiment.

### DETAILED DESCRIPTION

Methods, computer program products, and systems for securing network data during physical intrusions of OT systems and devices. The following disclosure is limited only for the purpose of conciseness, as one of ordinary skill in the art will recognize additional embodiments given the ones described herein. For example, the techniques disclosed herein can be applied to other OT systems besides ATMs, and also Internet of Things (IoT) devices such as industrial equipment, alarm systems, smart shoes, smart televisions, and the like.

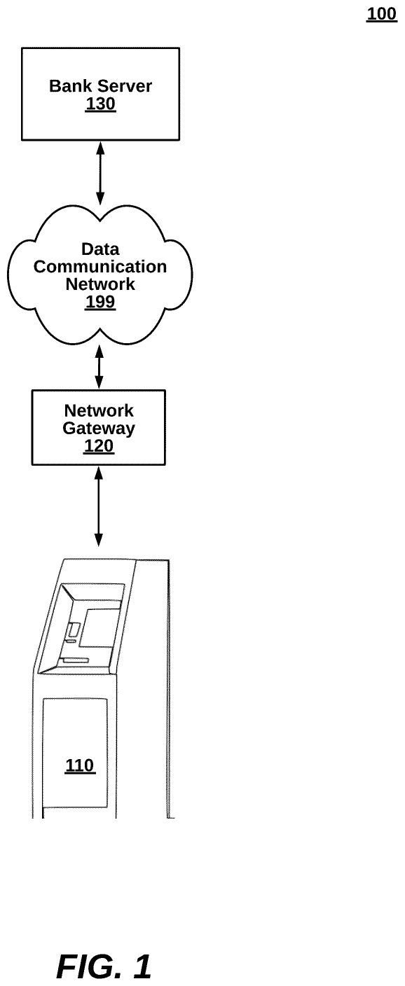

### I. Systems for Protecting OT Device Network Data (FIGS. 1-3)

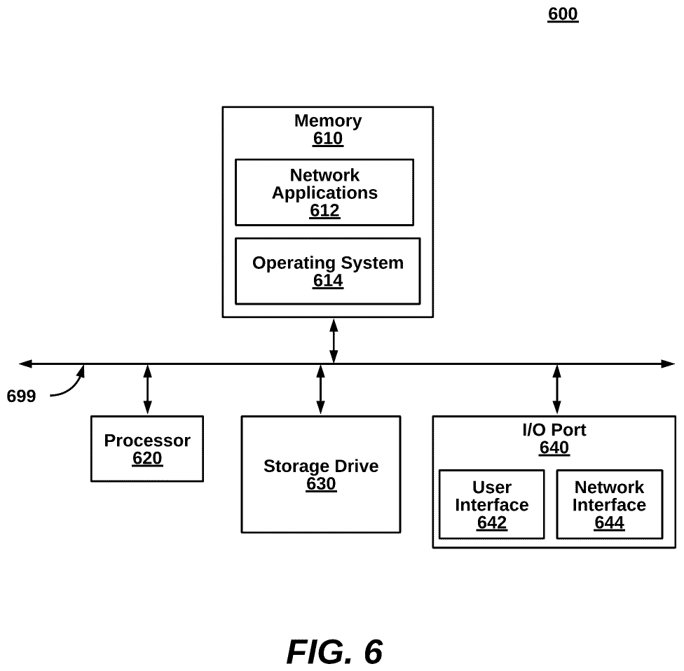

FIG. 1 is a high-level block diagram illustrating a system 100 for protecting network data during physical intrusions of OT devices, according to an embodiment. The system 100 includes remote ATM machines 110 connected to a bank server 120 over a data communication network 199. Other embodiments of the system 100 can include additional components that are not shown in FIG. 1, such as routers, switches, access points, and IT devices. Further, there can be more network gateways, access points and switches, and edge devices. The components of system 100 can be implemented in hardware, software, or a combination of both. An example implementation is shown in FIG. 6. The system 100 can also include other OT devices and also Internet of Things (IoT) devices, with rugged firewalls, such as industrial equipment, alarm systems, smart shoes, smart televisions, and the like.

In one embodiment, the components of the system 100 are coupled in communication over a private network connected to a public network, such as the Internet. In another embodiment, system 100 is an isolated, private network, or alternatively, a set of geographically dispersed LANs. The components can be connected to the data communication system via hard wire (e.g., ATM machine 110, network gateway 120, and bank server 130). The components can also be connected via wireless networking (e.g., ATM machine 110). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

In one embodiment, the remote ATM machine 110 can be an OT device operating as a remote terminal for the bank server 130 to dispense currency and provide account information. To do so, a communication channel is activated for secure communications of sensitive data. The sensitive data can be related to individual user accounts, such as account numbers, debit card numbers, pin numbers and passwords. Furthermore, sensitive data can be related to network connections, such as private IP addresses, specific port numbers, authentication passwords, encryption types, and the like. Before using, the ATM machine 110 authenticates to a Wi-Fi or cellular network for access to a channel through a network gateway 120 or other access controller. A VPN tunnel can be set up with data to secure cross-network communications between the end points. Next, the ATM machine 110 authenticates to the bank server 130. Finally, an individual user inserts a debit card and types in a PIN code that is sent to the bank server 130 to access a particular account for private transactions. Once these network transactions are satisfied, the ATM 110 can physically dispense currency or perform other tasks (e.g., print out or display a receipt showing a balance of funds available for a user's account).

A tolerable threshold is a subjective parameter that can be programmed to the ATM machine 110. One threshold, movement, can be set to detect when the ATM machine 110 has been physically compromised and is in the process of being removed from its location. The parameters can be set to detect any type of movement, such as tilting or 2 inches of vertical or lateral movement, for example, when the ATM machine 110 is bolted down and not expected to have any movement. In another setting, an ATM machine 110 with wheels that is often pushed around a store to different locations can have more liberal parameters. A mobile robot ATM that moves around a casino or other location can be programmed with an expected route, or be dynamically updated with approved movements, to allow even more liberal parameters.

The ATM machine 110 can be a standalone machine constructure of wood, metal, plastic and/or rubber. An electrical outlet provides power for operation, including network capabilities. As an OT, a thin, special purpose operating system and applications load up when powered on. A network interface identifies a communication channel, such as Wi-Fi, cellular or Ethernet, and connects the ATM machine 110 to cloud resources. Hundreds of ATM machines can connect to a single bank server 130. Alternatively, the ATM machine 110 can be configured for connection to several different bank servers (i.e., of the same bank or different banks). A credit card machine or cash register are similar OT devices that may also be located near the ATM. Other OT devices can have different mission-critical functions.

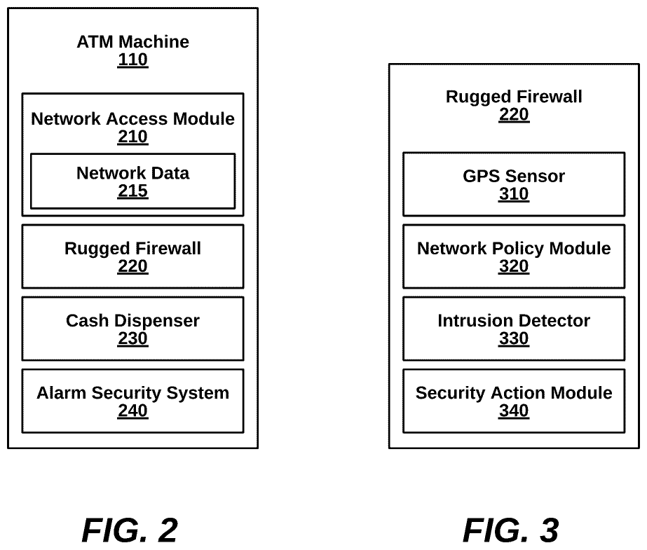

FIG. 2 is a more detailed block diagram illustrating a remote ATM device 110, according to an embodiment. The ATM device 110 includes a network access module 210 to connect with the bank server 110 through a rugged firewall 220. The network access module 210 further includes network data 215. The network data can be stored on a memory device (e.g., flash memory device) and have little protection from hacking. The network data 215 can be destroyed by the rugged firewall 220 by, for example, a delete command, an overwrite command, a format command, data corruption techniques (e.g., data encryption or data scrambling) or the like.

The rugged firewall 220 can be an all-in-one hardware device or appliance designed to protect mission-critical devices from cyber threats in harsh environments commonly found in industrial networks and OT. The design can withstand extreme temperature and humidity conditions that standard IT devices may not be subject to. There can also be a resistance to shock and vibration. Further, the rugged firewall 220 can operate in environments with high levels of electrical and/or radio frequency interference. Next-generation firewall can be supported along with industry-specific protocols. Interfaces can include USB, RJ45, serial and power inputs.

A cash dispenser 230 of the ATM 110 outputs cash for a user. An ATM alarm security system 240 protects the ATM machine 110 from physical intrusion with locks and audible alarms. A physical lock can trip an audible alarm or flashing lights when broken. This conventional alarm can be in communication with the rugged firewall 120 to notify of a physical break in.

FIG. 3 is a more detailed block diagram illustrating the rugged OT firewall 20 of the system of FIG. 1, according to one embodiment. The rugged OT firewall 220 includes a GPS sensor 310, a network policy module 320, an intrusion detector module 330, and a security action module 340. The components can be implemented in hardware, software, or a combination of both.

The GPS sensor 310 determines a current GPS position of an OT device. The positions can be logged and timestamped. A position can checked periodically, or responsive to triggers, such as movement or ambient changes. In one embodiment, the GPS sensor 210 is part of the rugged firewall and in other embodiments, an ATM machine already includes a GPS sensor that can be read by the GPS sensor 310. Some implementations use other positioning technologies, such as Wi-Fi location, cell tower location, signal triangulation, and the like.

A network policy module 320 can receive a tolerable deviation in GPS position for the OT device from the current GPS position as defined by a network security policy. The tolerable deviation can be a default, manual setting, or automatic setting with intelligent updates. In one case, the tolerable deviation is overridden by another security policy. For example, an ATM being intentionally moved to another location can be set into an override mode. In another example, the tolerable deviation is dynamic based on expected movements. An ATM located in a vehicle or cruise ship can interact with a routing process feeds expected locations for a vehicle route or a shipping route. For multiple input embodiments, an array of tolerable deviations can be set for different inputs.

The intrusion detector 330 can detect, in real-time, a violation of the tolerable deviation in the OT device from the current GPS position. In one case, a difference between a current GPS position and a previous (or predefined) GPS position triggers a suspected intrusion alarm. In another case, multiple inputs are considered for intrusion detection, including position changes, pressure sensors, vibration sensors, a gyroscope, and temperature sensors, for example. If an intrusion is detected, a notification can be sent to the security action module 340 to implement a security action.

The security action module 340, in response to the detected violation, takes security action involving a self-reset to destroy network data in the rugged firewall of the OT device. The network data is assessable by the rugged firewall. In other implementations, financial data, passwords, and other information can be deleted. Various techniques for data deletion are possible.

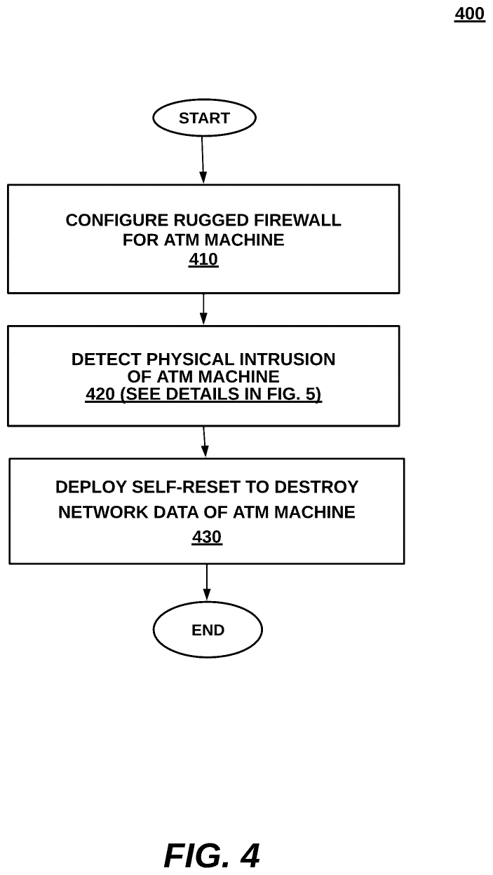

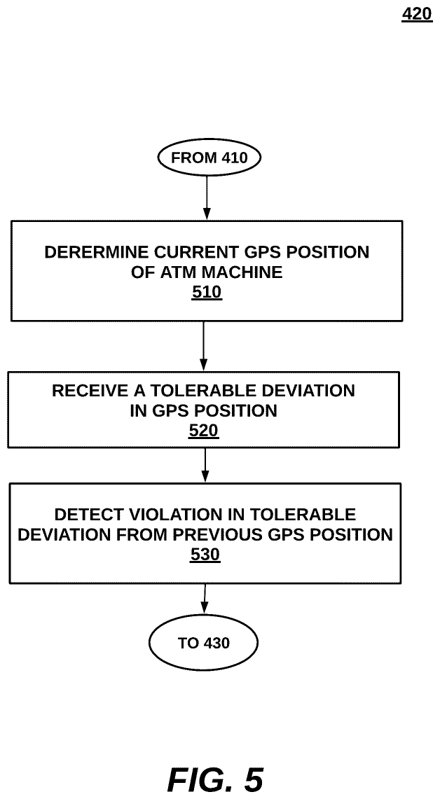

### II. Methods for Protecting OT Device Network Data (FIGS. 4-5)

FIG. 4 is a high-level flow diagram of a method 400 for protecting network data during physical intrusions of OT devices, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 410, a rugged firewall is configured for an ATM machine. One implementation requires the rugged firewall to be installed as an original equipment manufacture (OEM), during or after manufacture. An adapter plug can connect the rugged firewall to a chassis or to a motherboard. At step 420, a physical intrusion of the ATM machine is detected. Responsive to a detected intrusion, at step 430, a self-reset is deployed to destroy network data.

FIG. 5 details to step 420 of detecting a physical intrusion of the ATM machine. In particular, at step 510 a current GPS position of the ATM machine is determined. At step 520, a tolerable deviation in GPS position is received for the OT device from the current GPS position as defined by a network security policy. At step 530, a violation of the tolerable deviation is detected in the OT device from the current GPS position. In one case, deviations can be overridden. In another case, anomalies in other sensors are also detected, and one or more of the deviations can be combined to determine if a total tolerable deviation is acceptable.

### III. Computing Device for Protecting OT Device Network Data (FIG. 6)

FIG. 6 is a block diagram illustrating a computing device 600 for use in the system 100 of FIG. 1, according to one embodiment. The computing device 600 is a non-limiting example device for implementing each of the components of the system 100, including ATM device 110, network gateway 120, and bank server 130. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)).

Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

I claim:

1. A computer-implemented method in a rugged firewall device for protecting against compromise of network data during physical intrusions of operational technology (OT) devices, the method comprising the steps:
storing network data for the rugged firewall on a memory device;
determining a current global positioning satellite (GPS)_ position of an OT device;
receiving a tolerable deviation in GPS position for the OT device from the current GPS position as defined by a network security policy;
detecting in real-time a violation of the tolerable deviation in the OT device from the current GPS position; and
in response to the detected violation, taking security action involving a self-reset to factory default to destroy the network data of the rugged firewall.

2. The method of claim 1, wherein the tolerable deviation from the current position is updated to allow a planned movement of the OT device.

3. The method of claim 2, wherein the OT device is disposed on an automobile, a mobile robot or a cruise ship.

4. The method of claim 1, wherein the OT device comprises an automated teller machine (ATM) device.

5. The method of claim 1, wherein the OT device comprises one or more sensors, and wherein the violation is detected responsive to an anomaly indicative of physical intrusion of the OT device with respect to the one more sensors.

6. The method of claim 5, wherein the violation is detected responsive to an artificial intelligence analysis of signals received from the one or more inputs.

7. The method of claim 1, wherein the detected violation is overridden by a different network policy.

8. The method of claim 1, wherein the GPS is embedded in the rugged firewall.

9. The method of claim 1, wherein the GPS is native to the OT device and a signal is received indicative of the current position and for deviations from the current position.

10. The method of claim 1, wherein the rugged firewall receives an intrusion signal from an alarm system native to the OT device.

11. The method of claim 1, wherein the self-reset comprises overwriting the network data of the rugged firewall.

12. The method of claim 1, wherein the self-reset comprises corrupting the network data of the rugged firewall.

13. The method of claim 1, wherein storing the network data comprises storing the network data for the rugged firewall on a flash memory device.

14. A non-transitory computer-readable medium in a rugged firewall device, on a data communication network, storing code that when executed, performing a method protecting against compromise of network data during physical intrusions of operational technology (OT) devices, the method comprising:
storing network data for the rugged firewall on a memory device;
determining a current GPS position of an OT device;
receiving a tolerable deviation in GPS position for the OT device from the current GPS position as defined by a network security policy;
detecting in real-time a violation of the tolerable deviation in the OT device from the current GPS position; and
in response to the detected violation, taking security action involving a self-reset to factory default to destroy the network data of the rugged firewall.

15. A network security device, on a data communication network, for protecting against compromise of network data during physical intrusions of operational technology (OT) devices, the network security device comprising:
a processor;
a network interface communicatively coupled to the processor and to a data communication network;
a flash memory, communicatively coupled to the network interface and storing network data and
a memory, communicatively coupled to the processor and comprising:
a GPS sensor to determine a current GPS position of an OT device;
a network policy module to receive a tolerable deviation in GPS position for the OT device from the current GPS position as defined by a network security policy;
an intrusion detector to detect in real-time a violation of the tolerable deviation in the OT device from the current GPS position; and
a security action module to, in response to the detected violation, take security action involving a self-reset to factory default to destroy the network data of the rugged firewall.
